(19) United States
(12) Patent Application Publication
(10) Pub. No.: US 2011/0254420 A1
(43) Pub. Date: Oct. 20, 2011

(54) Adjustable Cabinet Drawer Pullout System

(76) Inventor: Kevin Esparza, Oak Hill, FL (US)

(21) Appl. No.: 12/761,683

(22) Filed: Apr. 16, 2010

(51) Int. Cl. A47B 88/16; F16M 13/02

(52) U.S. Cl. 312/334.8; 312/334.1; 312/334.7; 248/205.1; 248/224.7; 248/201

(57) ABSTRACT

An adjustable cabinet drawer pullout system is disclosed. The system includes an elongated bracket having a channel along its length. In addition, the system includes at least one carriage stop adapted to slide within the channel, at least one slot in a bottom of the channel, and a pin adapted to fit through the carriage stop and the slot. The pin is further adapted to insert into vertical line borings of a cabinet to secure the bracket to the cabinet. The pin is adjustable along the length of the bracket by moving the carriage stop to accommodate a horizontal alignment of the vertical line borings within the cabinet. A cabinet slide rail is secured to the bracket and the mounting height of the drawer pullout within the cabinet is adjustable by securing the bracket at the desired height using the pin and vertical line borings.

### BACKGROUND

I. Field of the Invention

The present invention relates generally to an adjustable cabinet drawer pullout system.

II. Background

The proper installation of pullout drawers within cabinets requires skilled labor and is difficult for the average homeowner. The drawers typically include a pair of slides that engage one another. One set of slides is permanently mounted to the interior sidewall of the cabinet and the second set of slides is permanently mounted to the side of the drawer box. The alignment of the slides within the cabinet is critical so that the drawer functions properly. In addition, to move installed drawers up or down after the initial installation is time consuming and difficult. Accordingly, what is needed is an adjustable drawer pullout system that is easy to install and has the ability to be vertically adjusted in a time efficient manner.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

Most cabinets today are manufactured with a series of vertical line borings that are used to support adjustable shelving. The vertical line borings are drilled at the four interior corners of the cabinet and the borings are typically spaced an inch or so apart. A peg can be inserted into a line boring at each of the four corners allowing a shelf to be supported by the pegs. The height of the shelf can be adjusted vertically be moving the pegs either up or down along the line borings. The present system utilizes the standard line borings in an adjustable drawer pullout system.

In a particular embodiment, the system includes an elongated bracket, where the elongated bracket includes a channel along its length. In addition, the system includes at least one carriage stop adapted to slide within the channel and at least one slot in a bottom of the channel. A pin is adapted to fit through the at least one carriage stop and the at least one slot to secure the bracket to a sidewall of the cabinet. The channel of the bracket may be a dovetail channel and the carriage stop may include a tail configured to interlock within the dovetail channel. The at least one pin may be adapted to insert into an existing boring of vertical line of borings in an interior sidewall of the cabinet to secure the elongated bracket to the sidewall. The pin may be threaded such as a screw. A secondary support may also be included, where the secondary support may be a hold down screw, for example, to insert into a predrilled top portion of the bracket to support weights in excess of forty pounds if drawer slides being used will accommodate the weight according to manufacture specifications for the slides. The carriage stop may include a countersunk recess to allow a top portion of the pin to be flush to a top portion of the carriage stop when the pin is inserted into the boring. The elongated bracket may include at least one marking groove perpendicular to a longitudinal edge of the elongated bracket to indicate a length. In addition, the system may include a series of predrilled screw holes in the top portion to secure the elongated bracket to the sidewall of the cabinet. A second elongated bracket may be used to secure to an opposing interior sidewall of the cabinet. The system may include a rear mounting socket, where the rear mounting socket is adapted to receive a second end of the elongated bracket and to be secured to a rear interior wall of the cabinet. In addition, a thickness of the bracket may be adapted for various widths of manufactured cabinets. Typically, screws may be used with the predrilled holes for a face frame cabinet application after the desired height has been set. One screw may be used in the front and the back.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 is perspective view of a particular embodiment of an adjustable drawer pullout system;

FIG. 2 is a perspective view with the drawers removed showing an elongated bracket of the system;

FIG. 3 is an elevational view of the left side bracket;

FIG. 4 is an elevational view of the right side bracket;

FIG. 5 is a front view of the carriage stop;

FIG. 6 is a side view of the carriage stop;

FIG. 7 is a top view of the carriage stop;

FIG. 8 is a front view of the bracket mounted to the inside of a cabinet;

FIG. 9 is a top view of the bracket mounted to the inside of a cabinet;

FIG. 10 is a perspective view of the bracket being positioned for installation in the cabinet;

FIG. 11 is a perspective view of the bracket installed and the cabinet slide about to be secured to the bracket; and

FIG. 12 is a perspective view of a typical drawer slide rail used with the system.

### DETAILED DESCRIPTION OF THE PREFERRED EMBODIMENT

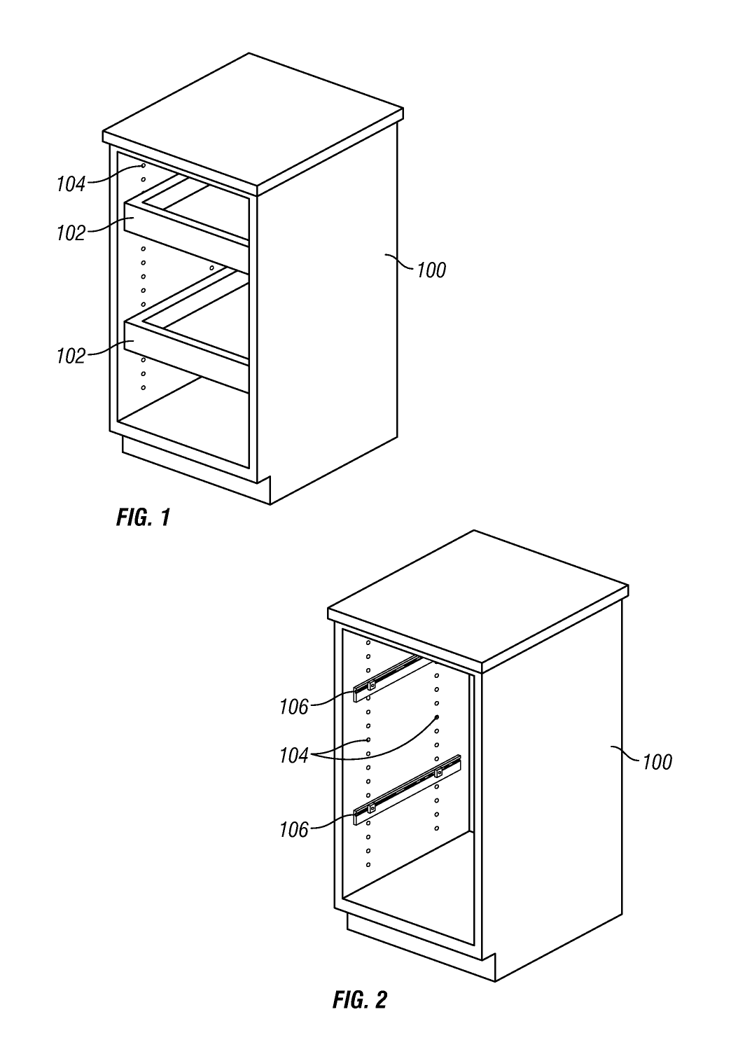

Referring to FIG. 1, a particular illustrative embodiment of an adjustable drawer pullout system is disclosed. A cabinet 100 includes a couple of drawer boxes or pullouts 102. In this particular example, there are two drawer pullouts 102 shown although any number of drawer pullouts 102 could be used with the system depending on the particular application. A series of vertical line borings 104 are used in part to secure the drawer box 102 to a sidewall of the cabinet 100. Typically there is at least a front and rear series of vertical line borings 104 on each sidewall of the cabinet 100. The line borings are made by the cabinet manufacturer so that a user can adjust the height of adjustable shelves. The present system is adapted to use the preexisting line borings to make for an easy installation of a drawer pullout 102. An elongated bracket 106 is secured to the sidewall of the cabinet 100 using a pin inserted into the line boring at a desired height.

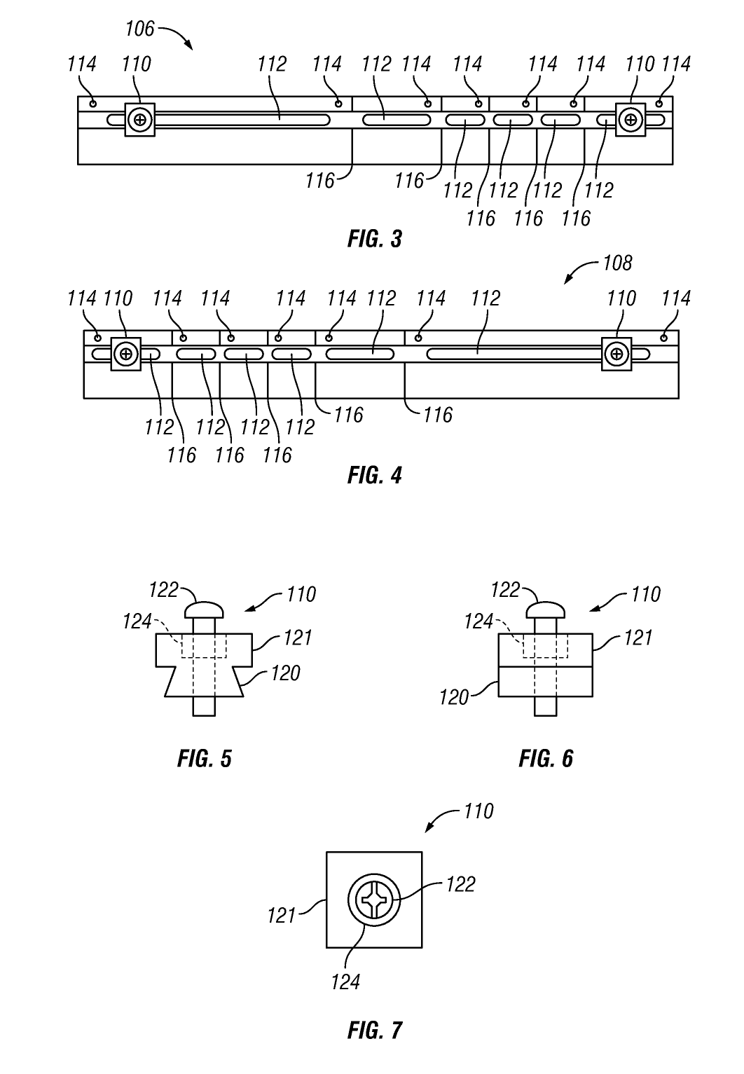

Referring now to FIGS. 3 and 4, the bracket 106 includes at least one carriage stop 110 that is adapted to slide within a channel of the bracket 106. FIG. 3 is a bracket 106 adapted for a first (e.g., left) sidewall and FIG. 4 is a bracket 108 adapted for a second (e.g., right) sidewall. The elements of the brackets 106, 108 are the same except for the left and right side relationship. Accordingly, a description of one bracket 106 is applicable to the second bracket 108. The width of the bracket 106 may be two and one-eighth inches or three and one-eighth inches or any desired width depending on the size and structural requirements of the drawer pullout 102. The channel is typically trapezoidal in shape to form a dovetail sliding connection with the carriage stop 110. Accordingly, the carriage stop 110 may include a tail 120 to interlock with the dovetail channel. The dovetail joint provides high resistance to the carriage stop 110 from being pulled out of the channel. A series of slots 112 may be formed in the bottom of the channel so that a pin 122 of each carriage stop 110 can be inserted through the bracket 106 into a line boring 104 and secure the bracket 106 to each sidewall of the cabinet 100. In operation, the bracket 106 is placed horizontally along the sidewall and the carriage stop 110 is slid to a position where the pin 122 is aligned with a line boring 104. The pin 122 is then inserted into the line boring 104. A carriage stop 110 is used at the rear and front portion of the bracket 106 so that the bracket 106 is supported in a horizontal orientation. The pin 122 may be any type of fastener including a bolt or screw with threading. The pin 122 also prevents the carriage stop 110 from moving. Marking grooves 116 may be disposed along the length of the bracket 106 and perpendicular to a longitudinal edge of the bracket for an easy homeowner application to cut the bracket to the desired length. The marking grooves 116 indicate a length from an end of the bracket so that the bracket 106 can be easily cut to a desired length depending on the depth of the cabinet and pullouts. For example, the marking grooves may be at approximately ten, twelve, fourteen, eighteen, or twenty inches from an end of the bracket 106.

As illustrated in FIG. 5, the carriage stop 110 includes a tail 120, which slides within the channel of the bracket 106. In addition, the carriage stop includes a top flange 121 that spans across the channel of the bracket 106 and includes a countersunk recess 124 to allow a top portion of the pin 122 to be flush to a top portion of the flange 121 when the pin 122 is inserted into a line boring 104. FIG. 6 is a top view of the carriage stop 110 showing the flange 121 and tail 120. FIG. 7 is a top view of the carriage stop 110 showing the pin 122 seated within the countersunk recess 124 in the flange 121.

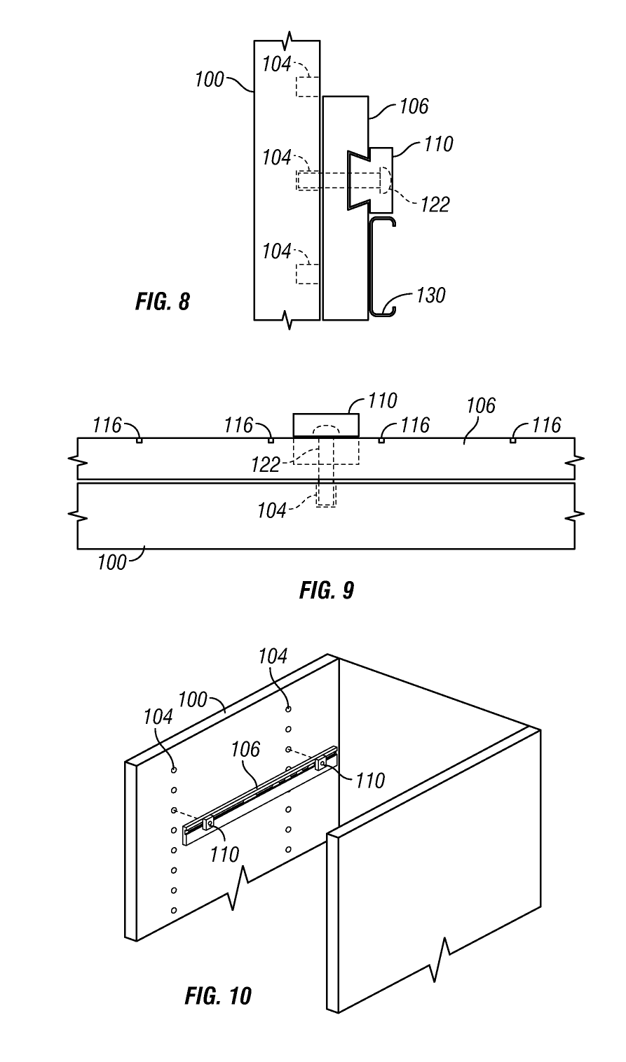

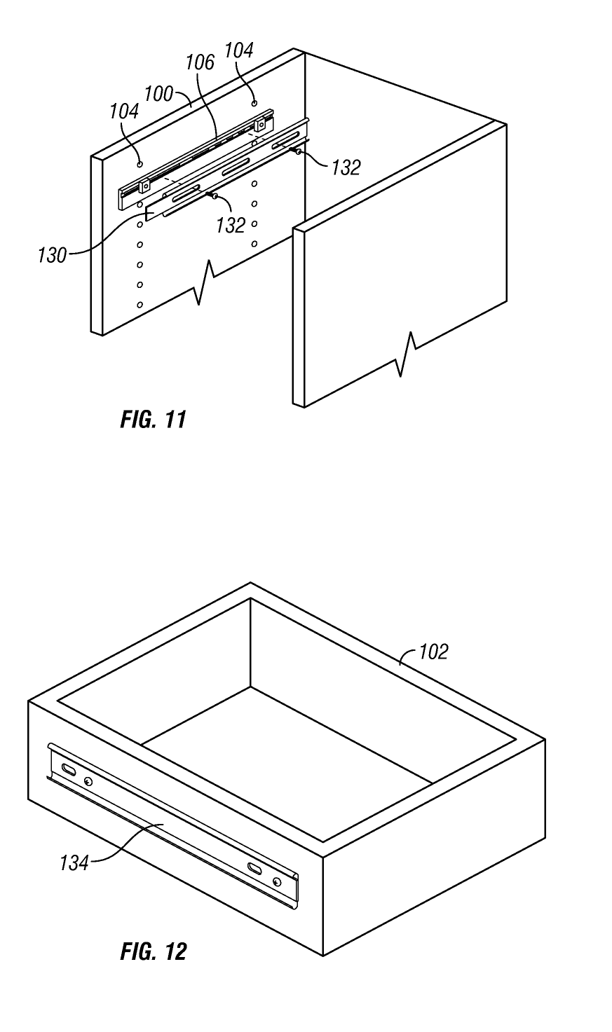

Referring now to FIGS. 8 and 9, the bracket 106 (e.g. left side) is shown installed on the sidewall of a cabinet 100. The bracket 106 is flush to the sidewall and the pin 122 is inserted into the line boring 104. As described above, the carriage stop 110 can be slid along the channel to align the pin 122 with the existing line boring 104.

The drawer pullout 102 may be adjusted to any desired height by moving the brackets 106, 108 up or down along the line borings 104 to the desired height as shown in FIG. 10. For example, the pin 122 may be withdrawn from the line boring 104 and the bracket is then aligned with the desired line boring 104 (up or down). The pin 122 is then inserted into the “new” desired boring 104 to secure the brackets 106, 108 to the sidewall of the cabinet 100. This is done with both the front and rear carriage stops 110 and for both brackets 106, 108 (e.g., left and right sides). The cabinet slides 130 can be mounted to the brackets 106, 108 using screws 132 before or after the brackets 106, 108 are mounted to the sidewalls of the cabinet 100. The cabinet slide 130 is placed adjacent to a bottom portion of the carriage stop 110 so that the cabinet slide 130 is easily aligned for installation into the cabinet 100. Once the brackets 106, 108 with the cabinet slides 130 are at the desired height, the drawer slide rails 134 can be engaged with the cabinet slide rails 132 and installed in the cabinet 100.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An adjustable cabinet drawer pullout system, the system comprising:
an elongated bracket, wherein the elongated bracket having a channel along its length;
at least one carriage stop adapted to slide within the channel;
at least one slot in a bottom of the channel; and
a pin adapted to fit through the at least one carriage stop and the at least one slot.

2. The system of claim 1, wherein the channel is a dovetail channel.

3. The system of claim 2, wherein the at least one carriage stop further comprising a tail to interlock within the dovetail channel.

4. The system of claim 3, wherein the at least one pin is further adapted to insert into a boring of a vertical line of borings in an interior sidewall of a cabinet to secure the elongated bracket to the sidewall.

5. The system of claim 4, wherein the carriage stop further comprising a countersunk recess to allow a top portion of the pin to be flush to a top portion of the carriage stop when the pin is inserted into the boring.

6. The system of claim 5, wherein the elongated bracket comprising at least one marking groove perpendicular to a longitudinal edge of the elongated bracket to indicate a length.

7. The system of claim 6, wherein the elongated bracket further comprising a series of screw holes to secure the elongated bracket to the sidewall of the cabinet.

8. The system of claim 7, further comprising a second elongated bracket to secure to an opposing interior sidewall of the cabinet.

9. The system of claim 8, wherein a total length of the elongated bracket is approximately twenty-three and one-half inches.

10. The system of claim 9, wherein a height of the elongated bracket is two and one-eighth inches or three and one-eighth inches.

11. The system of claim 10, wherein the at least one marking groove is approximately ten, twelve, fourteen, eighteen, or twenty inches from a first end of the elongated bracket.

12. The system of claim 11, further comprising a rear mounting socket, wherein the rear mounting socket is adapted to receive a second end of the elongated bracket and to be secured to a rear interior wall of the cabinet.

13. The system of claim 12, further comprising a cabinet slide rail secured to each of the elongated bracket and the second elongated bracket.

14. The system of claim 13, further comprising a drawer pullout adapted to engage the cabinet slide rails.

15. An adjustable cabinet drawer pullout system, the system comprising:
an elongated bracket; and
at least two pins secured to the elongated bracket, wherein the at least two pins are adapted to insert into a line of borings in an interior sidewall of a cabinet to secure the elongated bracket to the sidewall.

16. The system of claim 15, further comprising a rear mounting socket, wherein the rear mounting socket is adapted to receive an end of the elongated bracket and to be secured to a rear interior wall of the cabinet.

17. The system of claim 16, further comprising a series of screw holes to secure the elongated bracket to the sidewall of the cabinet.

18. The system of claim 17, further comprising a second elongated bracket to secure to an opposing interior sidewall of the cabinet.

19. The system of claim 18, further comprising a cabinet slide rail secured to each of the elongated bracket and the second elongated bracket.

20. The system of claim 19, further comprising a drawer pullout adapted to engage the cabinet slide rails.
